(19) United States
(12) Patent Application Publication
(10) Pub. No.: US 2018/0003134 A1
(43) Pub. Date: Jan. 4, 2018

(54) EGR DEVICE

(71) Applicant: DENSO CORPORATION, Kariya-city, Aichi-pref (JP)

(72) Inventors: Takashi KOBAYASHI, Kariya-city (JP); Osamu SHIMANE, Kariya-city (JP)

(21) Appl. No.: 15/542,749

(22) PCT Filed: Mar. 11, 2016
(86) PCT No.: PCT/JP2016/001378

§ 371 Date: Jul. 11, 2017

(30) Foreign Application Priority Data
Mar. 31, 2015 (JP) 2015-074282

(51) Int. Cl. F02M 26/67; F16K 31/04; F16K 1/226; F16K 41/00; F16K 1/22

(52) U.S. Cl. CPC F02M 26/67; F16K 41/00; F16K 1/224; F16K 1/2261; F16K 31/04

(57) ABSTRACT

An EGR device has a housing defining an EGR passage through which an EGR gas flows; a shaft rotatably supported by the housing through a bearing; a valve body adjusting a flow passage area of the EGR passage by rotating along with the shaft; and an actuator connected to one end portion of the shaft to drive the shaft. The bearing has a first bearing supporting one end portion of the shaft and a second bearing supporting the other end portion of the shaft. Moreover, a sealing member preventing fluid from flowing into the actuator is disposed at one end portion of the shaft. The housing has the chamber which accommodates the second bearing and is isolated form the exterior. The second bearing is made of a PPS resin material to which a fluororesin material is added. Thus, the second bearing is not corroded even if exposed to an atmosphere of strong acid.

### CROSS REFERENCE TO RELATED APPLICATION

This application is based on Japanese Patent Application No. 2015-74282 filed on Mar. 31, 2015, the disclosure of which is incorporated herein by reference.

### TECHNICAL FIELD

The present disclosure relates to an EGR device which recirculates a part of exhaust gas from an exhaust passage to an intake passage.

### BACKGROUND ART

It is well known that an EGR device which recirculates a part of exhaust gas from an exhaust passage to an intake passage through an EGR passage of an engine mounted on a vehicle (exhaust gas recirculated to the intake passage will be referred to as EGR gas, hereinafter).

Also, it is well known that the EGR device has a cantilever configuration for simplify its device structure. Such an EGR device is provided with a housing, a shaft, a valve body, and an actuator, which will be explained below in detail.

The housing has an EGR passage therein, through which the EGR gas flows. One end of the shaft is rotatably supported by the housing through a bearing. The valve is connected to the shaft so as to adjust a flow passage area of the EGR passage by rotating along with the shaft. The actuator is connected to the one end of the shaft to rotate the shaft.

That is, in such an EGR device, the shaft is supported by the housing only through the bearing disposed on the one end of the shaft. A sealing member is also disposed on the one end of the shaft in order to prevent the fluid from flowing into the actuator.

In recent years, it is required that a large amount of the EGR gas is recirculated into the engine in order to further improve a fuel economy and reduce an exhaust emission. However, when a large amount of the EGR gas is recirculated into the EGR passage, it is likely that the EGR device having a cantilever configuration may not support the valve sufficiently. Although it is considered that the shaft has a both end support mechanism, it will be necessary to provide a new additional bearing to the housing (refer to Patent Literature 1).

In a case that an additional bearing is provided to the housing, it is likely that gas and condensed water may flow into the housing through an accommodation space of the additional bearing. The gas and the condensed water can be prevented from flowing out into an exterior of the housing by isolating the accommodation space of the additional bearing from the exterior.

However, since the additional bearing is exposed to atmosphere of strong acid, it is likely that the additional bearing made of metal may be corroded.

### PRIOR ART LITERATURES

### Patent Literature

Patent Literature 1: JP 2011-058536 A

### SUMMARY OF THE INVENTION

It is an object of the present disclosure to provide a structure in which an additional bearing is prevented from being corroded when a shaft of an EGR device has a both end support mechanism.

According to the present disclosure, an EGR device is provided with a housing, a shaft, a valve body, and an actuator which will be explained below in detail. The housing has an EGR passage therein, through which the EGR gas flows. The shaft is rotatably supported by the housing through a bearing. The valve body is connected to the shaft so as to adjust a flow passage area of the EGR passage by rotating along with the shaft. The actuator is connected to the one end of the shaft to rotate the shaft.

The bearing has a first bearing supporting one end portion of the shaft and a second bearing supporting the other end portion of the shaft. Moreover, the sealing member preventing fluid from flowing into the actuator is disposed at one end portion of the shaft, and the housing has a chamber which accommodates the second bearing and is isolated form the exterior. The second bearing is made of a PPS resin material to which a fluororesin material is added.

In a case that the shaft has a both end support mechanism, the second bearing corresponds to an additional bearing, and the second bearing is made of a PPS (Poly Phenylene Sulfide) resin material to which a fluororesin material is added. The PPS resin material is resin material which is significantly excellent in heat resistance and acid resistance, and the fluororesin material is resin material which is significantly excellent in slidability.

Therefore, the PPS resin material to which the fluororesin material is added is significantly excellent in heat resistance, acid resistance, and slidability.

The second bearing is not corroded even if exposed to an atmosphere of strong acid. Even when the shaft of the EGR device is configured to be a both end support mechanism, the second bearing corresponding to an additional bearing can be prevented from be corroded.

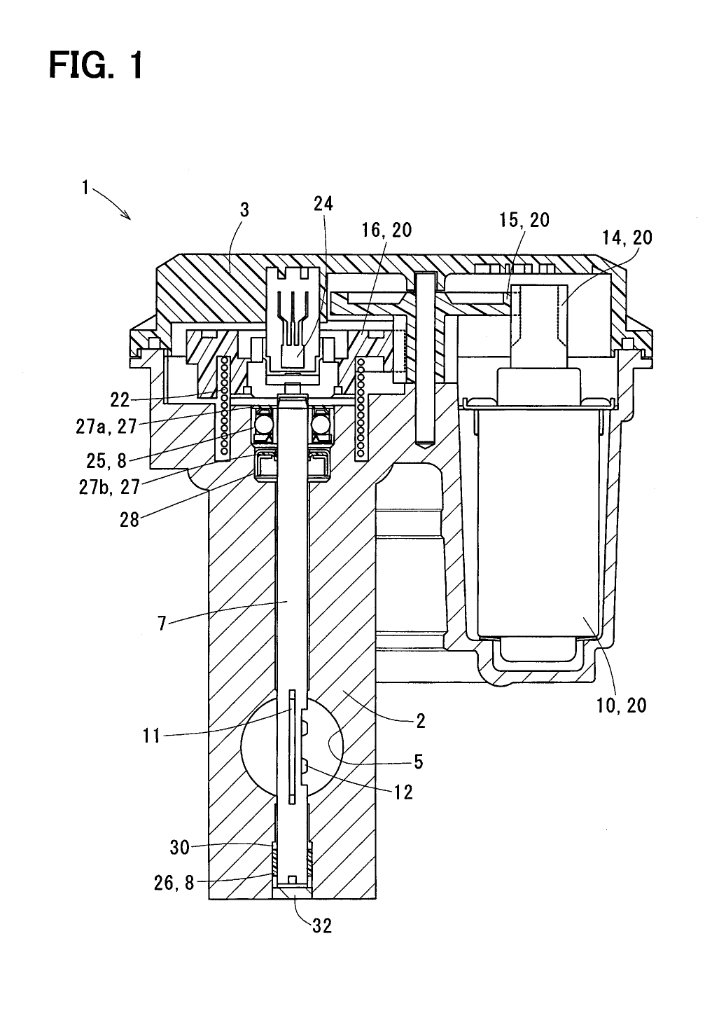

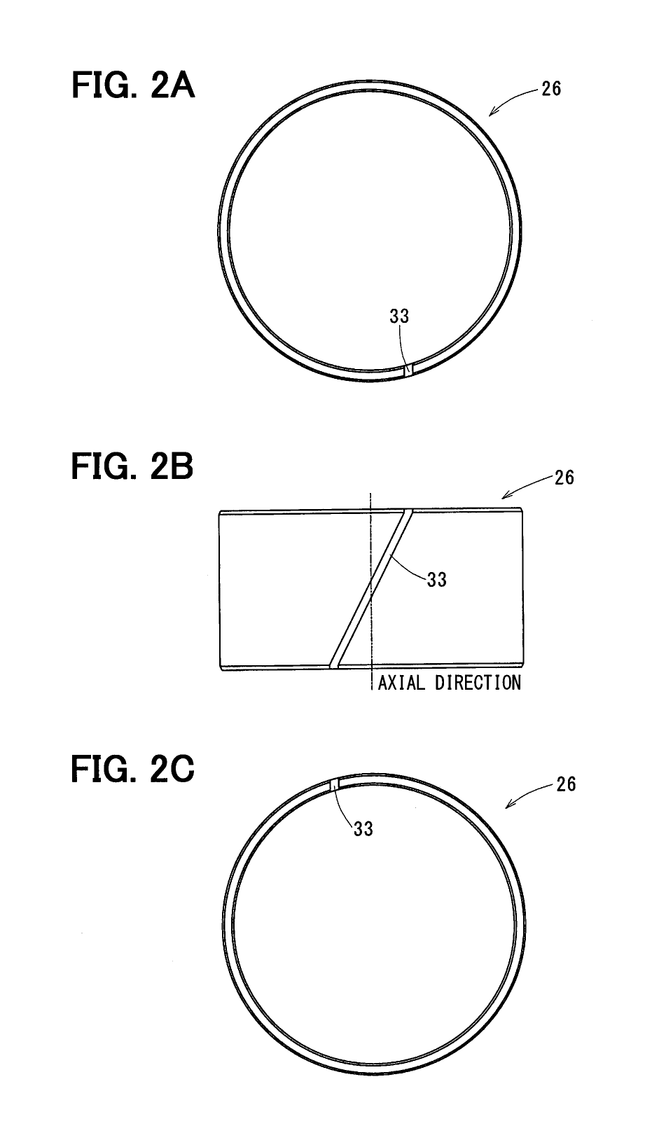

### BRIEF DESCRIPTION OF THE DRAWINGS

[FIG. 1] FIG. 1 is a local cross sectional view of an EGR device.

[FIG. 2A] FIG. 2A is a plan view of a second bearing.

[FIG. 2B] FIG. 2B is a front view of the second bearing.

[FIG. 2C] FIG. 2C is a bottom view of the second bearing.

### EMBODIMENTS FOR CARRYING OUT INVENTION

Hereafter, an embodiment of the present disclosure will be described.

(Configuration of Embodiment)

Referring to FIG. 1, a configuration of an EGR device 1 according to an embodiment will be described.

The EGR device 1 recirculates EGR gas from an exhaust passage to an intake passage of an engine mounted on a vehicle. The EGR device 1 is provided with a housing 2, a sensor case 3 and the like, as explained below.

The housing 2 is made from metallic material, such as aluminum alloy by die casting. An EGR passage 5 for recirculating the EGR gas from the exhaust passage to the intake passage is defined in the housing 2.

The EGR gas of which temperature exceeds 200° C. flows through the EGR passage 5. When the water content in EGR gas is cooled to be condensed, a condensed water of strong acid containing hydrochloric acid and sulfuric acid resulting from chlorine and sulfur contained in the fuel is generated in the EGR passage 5.

The housing 2 rotatably supports a shaft 7 through a bearing 8, and accommodates a motor 10 driving the shaft 7. It should be noted that the shaft 7 is made from heat-resistant material (stainless steel, heat resisting steel, etc.) which is excellent in heat resistance. The shaft 7 is columnar and rotates around its axis. That is, the valve body 11 fixed to the shaft 7 is also rotated around the axis of the shaft 7.

The valve body 11 is connected to the shaft 7 by multiple screws 12. The valve body 11 is a disc-shaped butterfly valve which rotates along with the shaft 7 so as to adjust a flow passage area of the EGR passage 5. It should be noted that both of the valve body 11 and the screws 12 are made from heat-resistant material (stainless steel, heat resisting steel, etc.) which is excellent in heat resistance.

A rotational speed of the motor 10 is decelerated by a combination of multiple gears, and an amplified running torque is transmitted to the valve body 11. Specifically, the rotational speed of the motor 10 is decelerated by a combination of a motor gear 14 rotating with the motor 10, an intermediate gear 15 driven by the motor gear 14, and a final gear 16 driven by the intermediate gear 15. The shaft 7 rotates along with the final gear 16.

A combination of the motor 10 and the deceleration mechanism (the motor gear 14, the intermediate gear 15, the final gear 16), which decelerates the rotation output of the motor 10 and increases the running torque, corresponds to an actuator 20. The actuator 20 is connected to one end of the shaft 7 so as to drive the shaft 7.

Moreover, the EGR device 1 is provided with a return spring 22 which biases the valve body 11 only in a valve-closing direction. The return spring 22 is a single spring of coil spring wound only one way, and is arranged around the shaft 7 coaxially.

The return spring 22 is assembled between the housing 2 and the final gear 16 to generate a spring force which biases the valve body 11 in the valve-closing direction. That is, the last gear 16 and the like are rotated against the spring force of the return spring 22.

The sensor case 3 is made of resin material, and accommodates a sensor 24 which detects a rotating angle of the valve body 11. It should be noted that the sensor 24 is a non-contact position sensor which detects an opening degree of the valve body 11 by detecting a rotating angle of the shaft 7. A flange of the housing 2 and a flange of the sensor case 3 are connected by screws, so that the body 2 and the sensor case 3 are united.

The bearing 8 has a first bearing 25 supporting one end portion of the shaft 7 and a second bearing 26 supporting the other end portion of the shaft 7. The first bearing 25 is a ball bearing supported by the housing 2. The first bearing 25 has a sealing member 27 made of fluorine-contained rubber 27a, which prevents gas from flowing into the actuator 30 from the EGR passage 5.

Furthermore, an oil seal 28 is disposed between the first bearing 25 and the EGR passage 5. The oil seal 28 includes a sealing member 27 made of fluororesin 27b, which prevents the condensed water from flowing into the actuator 20 from the EGR passage 5.

The sealing member 27 is positioned at one end portion of the shaft 7, which prevents the gas and the condensed water from flowing into the actuator 20.

The second bearing 26 is a sliding bearing supported by the housing 2, and is made of PPS resin material to which fluororesin material is added. It should be noted that PPS resin material is resin material which is significantly excellent in heat resistance and acid resistance. By adding fluororesin material, its slidability is also ensured.

When a content rate of the fluororesin material in the PPS resin material is less than 35%, the slidability becomes insufficient, so that abrasion wear of the second bearing 26 increases. Thus, it is preferable that the content rate of the fluororesin material in the PPS resin material is not less than 35%. The second bearing 26 is press-fit into a chamber 30. The chamber 30 is closed by a plug 32 so that the chamber 30 is isolated from the exterior.

As shown in FIG. 2 A, FIG. 2 B, and FIG. 2 C, the second bearing 26 is a cylinder having a slit 33 inclined relative to an axial direction in such a manner as to absorb a difference of its linear expansion.

It should be noted that the slit 33 is inclined relative to the axial direction in order to avoid a generation of a region in which the shaft 7 has no contacting area in the axial direction, which causes an increase in resistance when the shaft 7 slides.

Moreover, since the second bearing 26 is made of resin material, the second bearing 26 can be formed by a general injection molding, and its design degree of freedom is also high.

(Advantage of Embodiment)

According to the present embodiment, the EGR device 1 has the bearing 8 including the first bearing 25 supporting one end portion of the shaft 7 and the second bearing 26 supporting the other end portion of the shaft 7. Moreover, the sealing member 27 preventing fluid from flowing into the actuator 20 is disposed at one end portion of the shaft 7, and the housing 2 has the chamber 30 which accommodates the second bearing 26 and is isolated form the exterior. The second bearing 26 is made of PPS resin material to which fluororesin material is added.

In a case that the shaft has a both end support mechanism, the second bearing 26 corresponds to an additional bearing. Since the second bearing 26 is formed of PPS resin material to which fluororesin material is added, the second bearing 26 is not corroded even if exposed to the atmosphere of strong acid. Therefore, also when the shaft 7 of the EGR device 1 is configured to be a both end support mechanism, the second bearing 26 corresponding to an additional bearing can be prevented from corrosion.

Since the second bearing 26 is a bulk component, its effect will not disappear due to shaving or peeling, unlike coating agent.

The second bearing 26 is press-fit into the chamber 30. The chamber 30 is closed by the plug 32 so that the chamber 30 is isolated from the exterior. Therefore, gas and condensed water do not flow out into an exterior of the housing 2.

The oil seal 28 is disposed between the first bearing 25 and the EGR passage 5. The oil seal 28 includes the sealing member 27 made of fluororesin 27b, which prevents the condensed water from flowing into the actuator 20 from the EGR passage 5. By adopting fluororesin 27b as the sealing member 27 which prevents the condensed water from flowing into the actuator 20 from the EGR passage 5, a permeation of condensed water can be surely prevented rather than using the component made of rubber which is swelled by the condensed water to deteriorate its seal efficiency.

The first bearing 25 is a ball bearing supported by the housing 2. The first bearing 25 has the sealing member 27 made of fluorine-contained rubber 27a, which prevents gas from flowing into the actuator 30 from the EGR passage 5. By adopting fluororesin 27a as the sealing member 27, the gas from which condensed water is can be surely preventing from flowing into the actuator 20.

Therefore, according to the present embodiment, after the condensed water is removed by the oil seal 28, the fluorine-contained rubber of the ball bearing can prevent the gas from flowing into the actuator 20.

[Modification]

The present disclosure is intended to cover various modification and equivalent arrangements.

For example, according to the above embodiment, although the second bearing 26 is a sliding bearing, the second bearing 26 can be a roller bearing such as a ball bearing or a needle bearing.

1. An EGR device comprising:
a housing defining an EGR passage through which an EGR gas flows;
a shaft rotatably supported by the housing through a bearing;
a valve body connected to the shaft so as to adjust a flow passage area of the EGR passage by rotating along with the shaft; and
an actuator connected to one end portion of the shaft to drive the shaft, wherein
the bearing has a first bearing supporting one end portion of the shaft and a second bearing supporting the other end portion of the shaft;
a sealing member is disposed on the one end portion of the shaft in order to prevent the fluid from flowing into the actuator;
the housing has a chamber accommodating the second bearing, which is isolated from an exterior; and
the second bearing is made of a PPS resin material to which a fluororesin material is added.
